(19) United States
(12) Patent Application Publication
(10) Pub. No.: US 2026/0351127 A1
(43) Pub. Date: Nov. 5, 2026

(54) REAL-TIME PREDICTION AND DYNAMIC SCHEDULING METHOD AND SYSTEM FOR AIRCRAFT TAXIING CONFLICT ON AIRPORT SURFACE

(71) Applicant: Tongji University, Shanghai (CN)

(72) Inventors: Yu Shen, Shanghai (CN); Peng Zhou, Shanghai (CN); Yangzhi Qiu, Shanghai (CN); Lin Yang, Shanghai (CN); Siyuan Yu, Shanghai (CN); Yuefeng Zheng, Shanghai (CN); Yuchuan Du, Shanghai (CN)

(21) Appl. No.: 19/390,423

(22) Filed: Nov. 14, 2025

(30) Foreign Application Priority Data
Apr. 30, 2025 (CN) 202510564534.5

(51) Int. Cl. G08G 5/80; G06N 7/01; G08G 5/20; G08G 5/34; G08G 5/51

(52) U.S. Cl. CPC G08G 5/80; G06N 7/01; G08G 5/20; G08G 5/34; G08G 5/51

(57) ABSTRACT

The disclosure relates to the technical field of air traffic management. Specifically provided is a real-time prediction and dynamic scheduling method for an aircraft taxiing conflict on an airport surface, including: collecting aircraft motion states and airport road network data, and generating original trajectories of aircraft using a hidden Markov model; predicting future taxiing trajectories of the aircraft to obtain predicted trajectories; utilizing a dynamic R-Tree spatial indexing technology to screen for potentially conflicting aircraft, and generating a dynamic risk value; executing a dynamic scheduling decision, and generating an aircraft detour path using a path generation algorithm; and re-planning a local path. In the disclosure, by fully considering the predicted taxiing trajectories of aircraft, the risk value of the taxiing conflict between the aircraft is predicted in advance and dynamic path adjustment is made, helping to reduce labor costs and enhance efficiency and safety of ground operations on an airport.

### CROSS-REFERENCE TO RELATED APPLICATION

This application claims priority of Chinese Patent Application No. 202510564534.5, filed on Apr. 30, 2025, the entire contents of which are incorporated herein by reference.

### TECHNICAL FIELD

The disclosure relates to the technical field of air traffic management, and specifically relates to a real-time prediction and dynamic scheduling method and system for an aircraft taxiing conflict on an airport surface.

### BACKGROUND

With the constant growth of air transport volume, the scale and operational complexity of modern airports have significantly increased. Ground taxiing conflicts at airports have become a critical bottleneck restricting operational efficiency and flight safety. Currently, the computer simulation-based airport operational efficiency evaluation models are extensively applied; however, there are still limitations in the existing conflict detection technologies.

Trajectory prediction refers to constructing a future taxiing path of an aircraft by integrating real-time state data with historical operational patterns of the aircraft, thereby achieving proactive assessment of conflict risks. In the prior art, the research on airport surface conflict detection and early warning mainly falls into two categories. One involves performing conflict determination on the basis of the instantaneous position data of the aircraft. This method can only identify explicit conflicts that have occurred, but lacks foresight into potential conflicts and lacks sufficient early warning time for conflicts, failing to leave adequate decision-making buffer time for controllers. The other category is based on the historical operation data, which leverages machine learning or mathematical statistics to extract common conflict patterns from historical trajectory databases. Although the analytical method based on historical data can identify common path conflict patterns, it has limited prediction accuracy in real-time dynamic scenarios. Moreover, most such methods overlook practical air traffic control operational situations in airports.

Currently, most studies lack the capability to dynamically predict taxiing conflicts in real time and perform path re-planning. The vast majority of systems remain confined to conflict alarming, and fail to form a closed-loop linkage with dynamic path re-planning technologies, making it difficult to meet the demands of large airline hubs for real-time conflict resolution and proactive scheduling.

### SUMMARY

In view of the above background, the disclosure provides a real-time prediction and dynamic scheduling method and system for an aircraft taxiing conflict on an airport surface to solve the above-mentioned problems existing in the prior art.

In one aspect, to realize the above objective, the disclosure provides a real-time prediction and dynamic scheduling method for an aircraft taxiing conflict on an airport surface. The real-time prediction and dynamic scheduling method for the aircraft taxiing conflict on the airport surface includes:
acquiring airport digital road network data, real-time aircraft signals, an air traffic control instruction, and flight plan data, performing data preprocessing, and generating original trajectories of aircraft using a hidden Markov model (HMM);
predicting future taxiing trajectories of the aircraft on the basis of the original trajectories, preprocessed real-time aircraft signals and preprocessed airport digital road network data to obtain predicted trajectories;
utilizing a dynamic R-Tree spatial indexing technology to screen for potentially conflicting aircraft on the basis of the predicted trajectories, determining whether the trajectories of the potentially conflicting aircraft intersect, and generating a dynamic risk value;
executing a dynamic scheduling decision on the basis of the dynamic risk value, and generating an aircraft detour path on the basis of a path generation algorithm; and
re-planning a local path using a receding horizon control (RHC) on the basis of real-time obtained data.

Furthermore, the airport digital road network data includes longitudes, latitudes, structures and lengths of a taxiway and a runway; the air traffic control instruction includes a waiting instruction and a path change instruction; and the flight plan data includes a taxiing path pre-stored in each aircraft.

Furthermore, a process of generating the original trajectories of the aircraft using the HMM includes:
inputting deviation distances between trajectory points and center lines of various taxiways into a Gaussian probability-density function to calculate observation probabilities for the HMM; constructing a state transition probability matrix on the basis of transition frequencies between nodes in historical trajectories, and mapping original trajectory points onto the center lines of the taxiways to generate corrected trajectories; and performing linear interpolation on the corrected trajectories to generate the original trajectories.

Furthermore, a process of predicting the future taxiing trajectories of the aircraft includes:
in a case that a prediction duration is no greater than remaining traveling time for a current taxiway section, predicting the trajectories on the basis of a uniform linear motion model;
in a case that the prediction duration is greater than the remaining traveling time for the current taxiway section, selecting a plurality of topologically connected paths for parallel prediction on the basis of an airport road network topology structure and the following priorities: a. pre-stored paths that match a flight plan database; b. paths specified by a real-time received air traffic control instruction; and c. feasible paths that satisfy a minimum turning radius of the aircraft; and stopping prediction in a case that a target runway entrance or a target parking stand entrance is detected; and
aggregating the trajectories of each aircraft over a future time period on the basis of predicted results to generate the predicted trajectories.

Furthermore, a process of utilizing the dynamic R-Tree spatial indexing technology to screen for the potentially conflicting aircraft includes:
covering the future trajectories of the aircraft within predicted time windows with minimum bounding rectangles (MBRs) on the basis of a dynamically expanded R-Tree index;
it is determined that a potential conflict exists between the two aircraft if an overlap is detected between the MBRs of the future trajectories of the two aircraft, and otherwise, it is determined that no potential conflict exists; and
the dynamically expanded R-Tree index is constructed by time slices, with each slice updated independently to adapt to dynamic motion.

Furthermore, during a process of determining whether the trajectories of the potentially conflicting aircraft intersect, if an intersection exists, an absolute value of a time difference between two aircraft arriving at an intersection point is calculated, and if no intersection exists, a minimum spacing distance between the two aircraft and an absolute value of a time difference between the two aircraft arriving at a closest point between the trajectories are calculated; and
a method for calculating the dynamic risk value is as follows:

$$Risk = \{ \begin{matrix}( α \cdot {e}^{- γΔ T} + β \cdot \frac{1}{Δ {D}_{min} + ϵ} + δ ) \cdot {w}_{direction} & ( trajectories intersect ) \\ ( α \cdot {e}^{- γΔ T} + β \cdot \frac{1}{Δ {D}_{min} + ϵ} ) \cdot {w}_{direction} & ( trajectories do not intersect )\end{matrix}$$

where ΔT is the absolute value of the time difference between the two aircraft arriving at the intersection point or the absolute value of the time difference between the two aircraft arriving at the closest point between the trajectories, and if ΔT=0, it is directly regarded as a highest conflict risk without the need for calculation via formulas; ΔDₘᵢₙ is the minimum spacing distance between the two aircraft; α is a time urgency weight; β is a distance sensitivity weight; γ is a time decay coefficient, controlling a rate at which ΔT affects risk; ϵ is a smoothing factor parameter; & is a fixed risk bonus parameter for an intersection scene; and w_{direction} is a direction weight.

Furthermore, a process of executing the dynamic scheduling decision on the basis of the dynamic risk value includes:
triggering a response measure on the basis of a level of the dynamic risk value, recording logs without intervention in a low risk scenario, sending an early warning to a control tower for manual monitoring in a medium risk scenario, and automatically generating an avoidance instruction in a high risk scenario, including a deceleration instruction or the detour path; and
determining the priority for aircraft avoidance, prioritizing deceleration or path adjustment to a trailing aircraft if the two aircraft travel in the same direction, and otherwise, prioritizing deceleration or path adjustment to an aircraft with a slower speed or greater payload; and prioritizing to adjust an aircraft on a descending taxiway if the two aircraft are heavy aircraft.

Furthermore, a process of generating the aircraft detour path on the basis of the path generation algorithm includes:
performing calculation on the basis of a cost function, a path length and a real-time conflict risk value, the cost function being as follows:

Total cost f(n)=g(n)+h(n)+μ·R(n)
where g(n) is a path cost from a current aircraft position to a node n; h(n) is a Manhattan distance from the node n to a target node; R(n) is a risk cost from the current aircraft position to the node n; and μ is a risk weight coefficient; calculation formulas for R(n) and g(n) being as follows:

$$R ( n ) = {\sum }_{i = 1}^{n} ( {Length}_{i} \cdot {Risk}_{i} )$$

$$g ( n ) = {\sum }_{i = 1}^{n} ( {Length}_{i} \cdot {BaseWeight}_{i} )$$

where Lengthᵢ is a physical length (in meters) of an iₜₕ taxiway section; Riskᵢ is a dynamic risk value of the iₜₕ taxiway section; and BaseWeightᵢ is a basic weight coefficient for the iₜₕ taxiway section; and
generating the detour path using an improved A* algorithm on the basis of the calculated total cost.

Furthermore, a process of generating the detour path using the improved A* algorithm includes:
an initialization phase: loading airport road network topology data, and defining a path start point S and a target point G; an open list being a set of nodes to be examined, initially containing only a start point, and a closed list being a set of nodes that have been examined, initially an empty set;
path search loop: if the open list is empty, terminating the process and returning to no solution, and otherwise, selecting a node n with a smallest total cost f(n) from the open list and moving same to the closed list; and if the current node n is the target point G, backtracking to output a complete path;
adjacent node expansion and filtering: generating all adjacent nodes of the current node n; filtering out adjacent nodes that violate a minimum turning radius constraint of the aircraft; and excluding nodes of the taxiway which have a one-way traveling direction conflicting with a current moving direction; and
node state update: if an adjacent node is not in the open list or the closed list, adding the adjacent node to the open list; if an adjacent node is already in the open list and a newly calculated value f(n) is better, updating a cost value and a parent node of the adjacent node; and then returning to the path search loop to continue searching until a goal point is reached or the open list is exhausted.

In another aspect, to realize the above objective, the present disclosure provides a real-time prediction and dynamic scheduling system for an aircraft taxiing conflict on an airport surface, which includes a data processing module, a trajectory prediction engine, a conflict detection engine, a dynamic scheduling decision-making module, and a visualization and alarm terminal.

The data processing module is configured to receive data and perform data preprocessing, and generate the original trajectories of the aircraft using the HMM;
the trajectory prediction engine is configured to predict the future taxiing trajectories of the aircraft on the basis of the original trajectories and the preprocessed data to obtain the predicted trajectories;
the conflict detection engine is configured to utilize the dynamic R-Tree spatial indexing technology to screen for the potentially conflicting aircraft, determine whether the trajectories of the potentially conflicting aircraft intersect, and generate the dynamic risk value;
the dynamic scheduling decision-making module is configured to execute the dynamic scheduling decision on the basis of the dynamic risk value, and generate the aircraft detour path on the basis of the path generation algorithm; and
the visualization and alarm terminal is configured to render a thermodynamic diagram of an airport digital road network, display a risk level, and display feedback of the dynamic scheduling decision.

Compared with the prior art, the disclosure has the following beneficial effects.

The disclosure provides a real-time prediction and dynamic scheduling method for an aircraft taxiing conflict on an airport surface, which includes a multi-modal trajectory prediction method. By fusing airport digital road network topology, an air traffic control instruction, flight plan data, and real-time aircraft ADS-B signals, an HMM is used for trajectory probability correction, and multi-path parallel prediction is achieved by combining with dynamic taxiing states.

A real-time detection and early warning method for a taxiing conflict in an airport provided in the disclosure includes spatio-temporal conflict detection and risk assessment. On the basis of a dynamic R-Tree spatial index, aircraft pairs with potential conflicts are screened, and a conflict risk assessment model integrating spatio-temporal factors (including a time difference, a minimum spacing distance, and a direction weight) is constructed.

In the disclosure, on the basis of the dynamic risk value of the aircraft pairs having potential conflicts, response measures are triggered according to levels. For cases requiring path adjustments, an improved A* algorithm and RHC are employed to generate the detour path, and a local path is re-planned on the basis of the latest data periodically.

In the disclosure, by fully considering the predicted taxiing trajectories of the aircraft, the risk value of the taxiing conflict between the aircraft is predicted in advance and dynamic path adjustment is made, helping to reduce labor costs and enhance the efficiency and safety of ground operations on the airport.

### BRIEF DESCRIPTION OF THE DRAWINGS

Upon reading the detailed description of the preferred embodiments below, various other advantages and benefits will become apparent to those of ordinary skill in the art. The accompanying drawings are intended solely for the purpose of illustrating the preferred embodiments, rather than limiting the scope of the disclosure. In the accompanying drawings:

FIG. 1 is a flow diagram of a real-time prediction and dynamic scheduling method for an aircraft taxiing conflict on an airport surface according to the disclosure;

FIG. 2 is a schematic diagram showing trajectories of an aircraft before and after treatment according to an embodiment of the disclosure;

FIG. 3 is a flowchart for conflict screening using an R-Tree index according to an embodiment of the disclosure;

FIG. 4 is a schematic diagram of an R-Tree hierarchical structure according to an embodiment of the disclosure;

FIG. 5 is a schematic diagram showing overlapping MBRs in time-sliced R-Tree according to an embodiment of the disclosure;

FIG. 6 is a flow diagram of the specific implementation process for an improved A* algorithm according to an embodiment of the disclosure;

FIG. 7 is a schematic diagram of a framework of a system according to an embodiment of the disclosure; and

FIG. 8 is a schematic diagram of a hardware deployment architecture of the system according to an embodiment of the disclosure.

### DETAILED DESCRIPTION

The exemplary embodiments of the disclosure will be described in more detail by reference to the accompanying drawings below. Although exemplary embodiments of the disclosure are shown in the accompanying drawings, it is to be understood that the disclosure can be realized in various forms and is not to be construed as limited to the embodiments set forth herein. On the contrary, the embodiments are provided to enable a more thorough understanding of the disclosure and to convey the complete scope of the disclosure to those skilled in the art. It is to be noted that the embodiments and features therein may be combined with each other without conflict. The disclosure is described in detail below with reference to the accompanying drawings and in conjunction with embodiments.

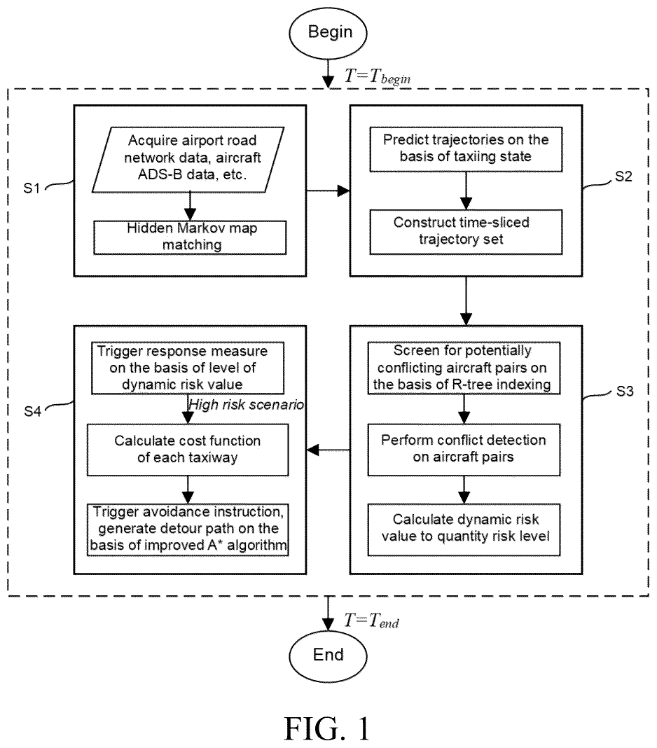

An embodiment provides a real-time prediction and dynamic scheduling method for an aircraft taxiing conflict on an airport surface, which, as shown in FIG. 1, specifically includes the following steps.

Step 1: data reception and trajectory processing: airport digital road network data, an air traffic control instruction, a flight plan database, and real-time aircraft ADS-B signals are acquired; outliers are filtered out on the basis of a preset acceleration threshold (set at ±3 m/s²) and heading change threshold (set at ±30°/s); and original trajectory points are mapped to center lines of taxiways on the basis of an HMM, where a state transition probability matrix of the HMM is obtained by statistical analysis of transition frequencies between nodes in historical trajectories.

Step 2: real-time prediction of taxiing trajectory: on the basis of the processed aircraft motion state data and airport digital road network topology relationship, taxiing trajectories of the aircraft over future time windows are predicted for two scenarios: a prediction duration is smaller than remaining traveling time of a current taxiway section, and the prediction duration is greater than or equals to the remaining traveling time of the current taxiway section.

Step 3: spatio-temporal conflict detection and risk assessment: on the basis of the predicted trajectories of the aircraft, potentially conflicting aircraft pairs are screened via a dynamic R-Tree spatial indexing technology; a future trajectory intersection point or closest point of the aircraft pairs is calculated; and a dynamic risk value is generated by integrating a time difference, a minimum spacing distance, and a motion direction weight.

Step 4: dynamic scheduling decision: on the basis of the dynamic risk value of the potentially conflicting aircraft pairs, a response measure is triggered according to preset three-level thresholds of the risk value.

The data reception and trajectory processing specifically include the following steps.

Step 1-1: airport digital road network data including longitudes, latitudes, structures and lengths of a taxiway and a runway, an air traffic control instruction including a waiting instruction and a path change instruction (taxiway switching, runway reallocation and parking position adjustment instructions), and a flight plan database including a pre-stored path and taxiing path of each aircraft are acquired.

Step 1-2: real-time aircraft ADS-B signals including position, velocity and heading angle are received, and outliers are filtered out on the basis of the preset acceleration threshold and heading change threshold.

Step 1-3: an HMM with a taxiway node set S={s₁, s₂, s₃, . . . , sₙ} as a state space is used to perform trajectory mapping, to map original trajectory points to center lines of taxiways. Observation probabilities of the HMM are obtained by inputting deviation distances between trajectory points and center lines of the taxiways into a Gaussian probability-density function. The observation probabilities of the HMM are calculated to be

$$P = \frac{1}{σ \sqrt{2 π}} {e}^{- \frac{{( d - μ )}^{2}}{2 {σ}^{2}}} ,$$

where d is a deviation distance, a mean value μ is set as 0 (ideal center line), and σ reflects tolerance for real deviation, and can be set as 2 m; a state transition probability matrix A=[aᵢⱼ] is obtained by statistically analyzing the transition frequencies between nodes in the historical trajectories:

$${a}_{ij} = \frac{{N}_{i \to j}}{{\sum }_{k = 1}^{n} {N}_{i \to k}}$$

where N_{i→j} represents the number of transitions from node sᵢ to node sⱼ in the historical data.

Step 1-4: the corrected trajectory data is subjected to linear interpolation (such as generating an interpolation point every 0.5 seconds) to improve the accuracy of the trajectory data.

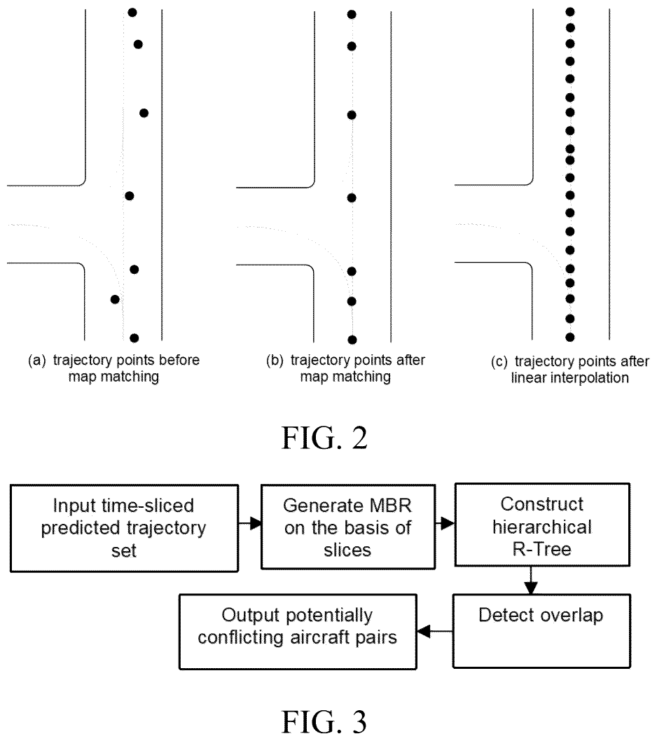

FIG. 2 is a schematic diagram showing trajectories of an aircraft before and after treatment.

The real-time prediction of taxiing trajectory specifically includes the following steps.

Step 2-1: trajectory prediction based on dynamic taxiing state, with the prediction duration set as 40 s
(1) In a case that a prediction duration t is smaller than or equals to remaining traveling time for a current taxiway section, trajectories are predicted on the basis of a uniform linear motion model. Assuming that the aircraft maintains uniform linear motion during the taxiing phase, the formula for calculating its future position is:

$$\{ \begin{matrix}x ( t ) = {x}_{0} + v \cdot cos θ \cdot t \\ y ( t ) = {y}_{0} + v \cdot sin θ \cdot t\end{matrix}$$

where (x₀, y₀) represents a current aircraft coordinate, v is a minimum value between the real-time speed of the aircraft and the speed limit of the taxiway, θ is a heading angle (relative to due north), and t is a future time period (in seconds).
(2) In a case that the prediction duration t is greater than the remaining traveling time for the current taxiway section, a plurality of topologically connected paths are selected for parallel prediction on the basis of an airport network topology and the following priorities: a. pre-stored paths matching the flight plan database, b. paths specified by a real-time received air traffic control instruction, and c. feasible paths satisfying a minimum turning radius of the aircraft.
(3) In a case that a target runway entrance or a target parking stand entrance is detected, distance prediction is stopped.

Step 2-2: a time-sliced trajectory set is constructed, and the set includes trajectories of each aircraft within the future time period t (t=40 s).

The spatio-temporal conflict detection and risk assessment specifically include the following steps.

Step 3-1: potential conflict screening: a dynamic R-Tree spatial indexing technology is used to rapidly screen for aircraft pairs with potential conflicts, and trajectory data is processed in batch by time slices.

Step 3-2: conflict detection technology: screened aircraft pairs having potential conflicts are traversed; whether the trajectories of the potentially conflicting aircraft pairs intersect within the future time period t is determined; if an intersection exists, an absolute value of a time difference between two aircraft arriving at an intersection point is calculated, and if no intersection exists, a minimum spacing distance between the two aircraft and an absolute value of a time difference between the two aircraft arriving at a closest point between the trajectories are calculated.

Step 3-3: conflict risk assessment: on the basis of future trajectory intersection point or closest point of the aircraft pairs, a dynamic risk value is generated by integrating a time difference, a minimum spacing distance, and a motion direction weight, to quantify the risk level.

FIG. 3 is a flowchart showing conflict screening using T-Tree. The specific process for potential conflict screening is as follows.

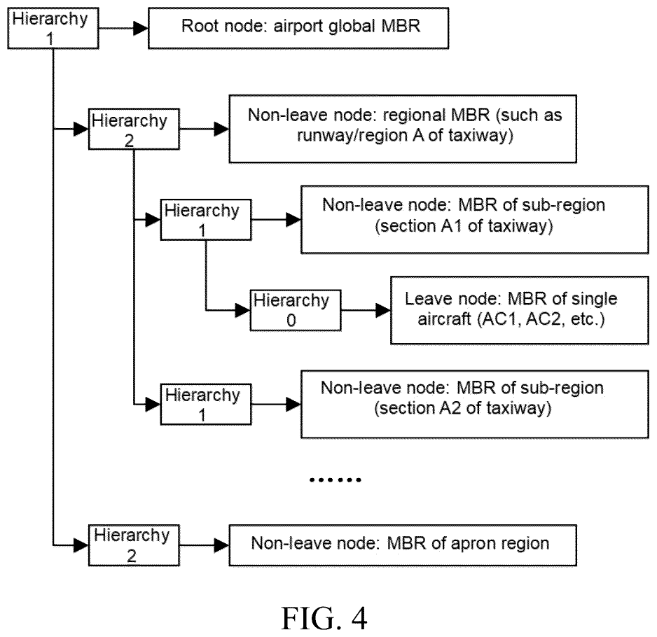

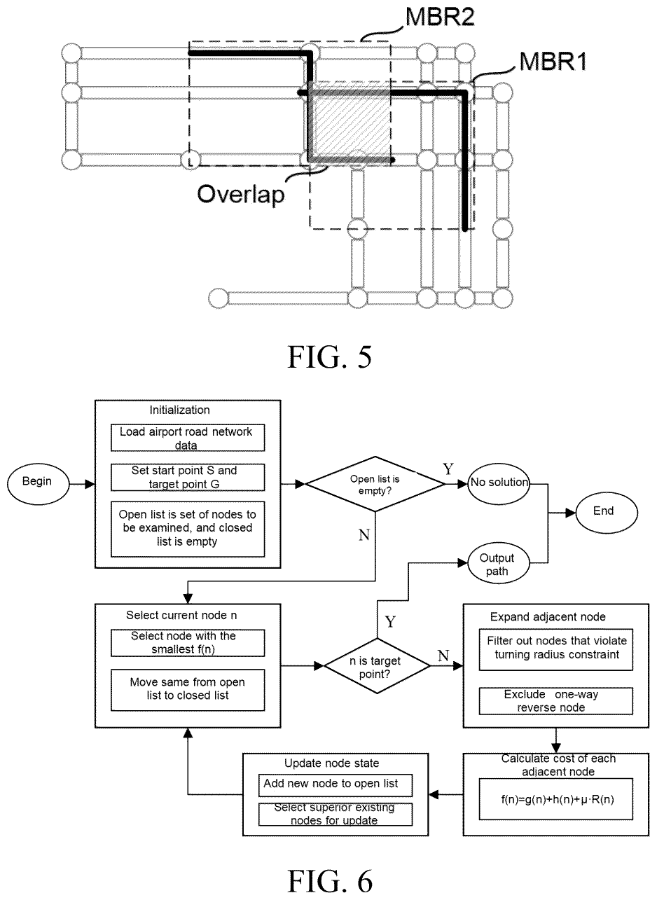

First, the time-sliced trajectory set based on the predicted trajectories of the aircraft obtained in step 2 is inputted, and then MBRs are generated for each time slice. The MBRs of the R-Tree index cover the future trajectories of aircraft within predicted time windows, and a hierarchical R-Tree (FIG. 4 demonstrates the R-Tree hierarchical structure) is constructed, followed by overlap detection. If the R-Tree index detects overlapping MBRs between the future trajectories of two aircraft, the aircraft pairs are identified as having potential conflict; otherwise, no potential conflict exists. FIG. 5 is a schematic diagram showing overlapping MBRs in time-sliced R-Tree, where the MBRs formed by the predicted trajectories of the two aircraft have an intersecting region, indicating potential conflict between the two aircraft. Finally, the aircraft pairs having potential conflicts are outputted.

The spatial indexing technology is a dynamically expanded R-Tree index, which is updated every 2 seconds. A forced update is triggered in a case that a speed of the aircraft changes by more than +10% or a heading changes by more than +5°.

The conflict risk assessment is specifically as follows.

The calculation formula for the dynamic risk value is:

$$Risk = \{ \begin{matrix}( α \cdot {e}^{- γΔ T} + β \cdot \frac{1}{Δ {D}_{min} + ϵ} + δ ) \cdot {w}_{direction} & ( trajectories intersect ) \\ ( α \cdot {e}^{- γΔ T} + β \cdot \frac{1}{Δ {D}_{min} + ϵ} ) \cdot {w}_{direction} & ( trajectories do not intersect )\end{matrix}$$

where ΔT represents the absolute value of the time difference between the two aircraft arriving at the intersection point (trajectories intersect) or the absolute value of the time difference between the two aircraft arriving at the closest point on the trajectories (trajectories do not intersect); if ΔT=0, it is directly regarded as the highest risk, without the need for calculation via formulas; ΔDₘᵢₙ is the minimum spacing distance between the two aircraft; α is a time urgency weight, with a value of 1.0 in an embodiment; β is a distance sensitivity weight, with a value of 1.5 in an embodiment; λ is a time decay coefficient, with a value of 0.1 in an embodiment, which controls a rate at which ΔT affects risk; ϵ is a smoothing factor parameter, which prevents numerical overflow when ΔDₘᵢₙ→0, with a value of 0.5 in an embodiment; δ is a fixed risk bonus parameter for an intersection scenario, with a value of 0.3 in an embodiment; and w_{direction} is a direction weight, set in segments according to the heading angle: in an embodiment, it is set as 0.2 for same direction (θ<30°), 1.0 for crossing (30°≤θ<150°), and 1.5 for opposite direction (θ≤150°).

For instance, a potential conflict is detected between aircraft A and aircraft B, where aircraft A has a speed of 15 m/s and a heading of 30°, while aircraft B has a speed of 10 m/s and a heading of 210°, with their predicted trajectories intersecting at point X of a taxiway. An intermediate quantity is calculated as follows:

ΔT=|(time for A arriving at point X)−(time for B arriving at point X)|=|80 s−120 s|=40 s

ΔDₘᵢₙ=25 m (closest distance between trajectories of the two aircraft)

θ=|210°−30°|=180°→w_{direction}=1.5 (opposite direction)

Finally, the current risk value is calculated to be 0.67.

The dynamic scheduling decision specifically includes the following steps.

Step 4-1: on the basis of the dynamic risk value of the potentially conflicting aircraft pairs, a response measure is triggered according to levels. In a low risk scenario (Risk<0.3), logs are recorded without intervention. In a medium risk scenario (0.3≤Risk<0.7), an early warning is sent to a control tower for manual monitoring. In a high risk scenario (Risk≥0.7), an avoidance instruction is automatically generated, including a deceleration instruction or generating a detour path on the basis of a path generation algorithm. Table 1 shows the risk level determination comparison in an embodiment.

TABLE 1

| Interval of risk value | Risk level | Response measure |
|---|---|---|
| (0, 0.3) | Low risk | Record logs without |
| | | interference |
| (0.3, 0.7) | Middle risk | Send yellow warning |
| | | prompt to control tower |
| ≥0.7 | High risk | Automatically generate |
| | | deceleration/path change |
| | | instruction |

According to Table 1, the risk value for aircraft A and aircraft B is 0.67, indicating that a yellow warning alert requires to be transmitted to the control tower.

Step 4-2: the priority for aircraft avoidance is determined. If the two aircraft travel in the same direction, priority is given to deceleration or path adjustment to a trailing aircraft, and otherwise, priority is given to deceleration or path adjustment to an aircraft with a slower speed or greater payload. If the two aircraft are heavy aircraft, priority is given to adjust an aircraft on a descending taxiway.

The path generation algorithm employs the improved A* algorithm. FIG. 6 shows the specific implementation process of the improved A* algorithm, including the following content.

An initialization phase: airport road network topology data is loaded, and a path start point S and a target point G are defined; an open list is a set of nodes to be examined, initially containing only a start point, and a closed list is a set of nodes that have been examined, initially an empty set.

Path search loop: if the open list is empty, the process is terminated and “no solution” is returned to, and otherwise, a node n with a smallest total cost f(n) is selected from the open list and is moved to the closed list; and if the current node n is the target point G, backtracking is performed to output a complete path.

Adjacent node expansion and filtering: all adjacent nodes of the current node n are generated; adjacent nodes that violate a minimum turning radius constraint of the aircraft are filtered out; and nodes of the taxiway which have a one-way traveling direction conflicting with a current moving direction are excluded.

Calculation is performed by combining a cost function with a path length and a real-time conflict risk value, a cost function being as follows:

Total cost f(n)=g(n)+h(n)+μ·R(n)
where h(n) represents a Manhattan distance from a node n to a target node; R(n) represents a risk cost from a current aircraft position to the node n; g(n) represents a path cost from the current aircraft position to the node n; μ is a risk weight coefficient, dynamically adjusted on the basis of airport operational state. In an embodiment, μ is set as 1.2 during peak periods (in a case that takeoff and landing frequency of airport exceeds 40 aircraft/hour), 0.8 during off-peak periods, 2.0 under emergency conditions (e.g., low visibility<800 m or emergencies on a runway). The calculation formulas for R(n) and g(n) are as follows:

$$R ( n ) = {\sum }_{i = 1}^{n} ( {Length}_{i} \cdot {Risk}_{i} )$$

$$g ( n ) = {\sum }_{i = 1}^{n} ( {Length}_{i} \cdot {BaseWeight}_{i} )$$

where Lengthᵢ is a physical length (in meters) of an iₜₕ taxiway section; Riskᵢ is a real-time risk value of the iₜₕ taxiway section, provided by conflict risk assessment method in real time; and BaseWeightᵢ is a basic weight coefficient for the iₜₕ taxiway section, which, in an embodiment, is set as 1.0 for the apron, 1.2 for the taxiway, and 1.5 for the runway according to the classification of regional importance.

Node state update: if an adjacent node is not in the open list or the closed list, the adjacent node is added to the open list; if an adjacent node is already in the open list and a newly calculated value f(n) is better, a cost value and a parent node of the adjacent node are updated; and then the path search loop is returned to continue searching until a goal point is reached or the open list is exhausted.

The path generation algorithm incorporates RHC, periodically re-planning a local path on the basis of the latest data. The re-planning cycle of the RHC is adjustable within a range of 5-30 seconds.

In the embodiment, during peak periods, a conflict (Risk=0.8) is detected between the planed paths of aircraft C and aircraft D. C is currently located at taxiway S1, and target parking stand G, and the candidate paths for aircraft C and cost thereof are as follows:
Candidate node 1: S1→S2 (length 200 m, Risk=0.8),
Cost is f(n)=200×1.2+350+0.8×200=750
Candidate node 2: S1→S3 (length 240 m, Risk=0),
Cost is f(n)=240×1.2+390=678

Although S2 is shorter, there is a risk of conflict. Therefore, aircraft C ultimately chose to travel from node S1 to node S3, achieving avoidance at the intersection during peak periods.

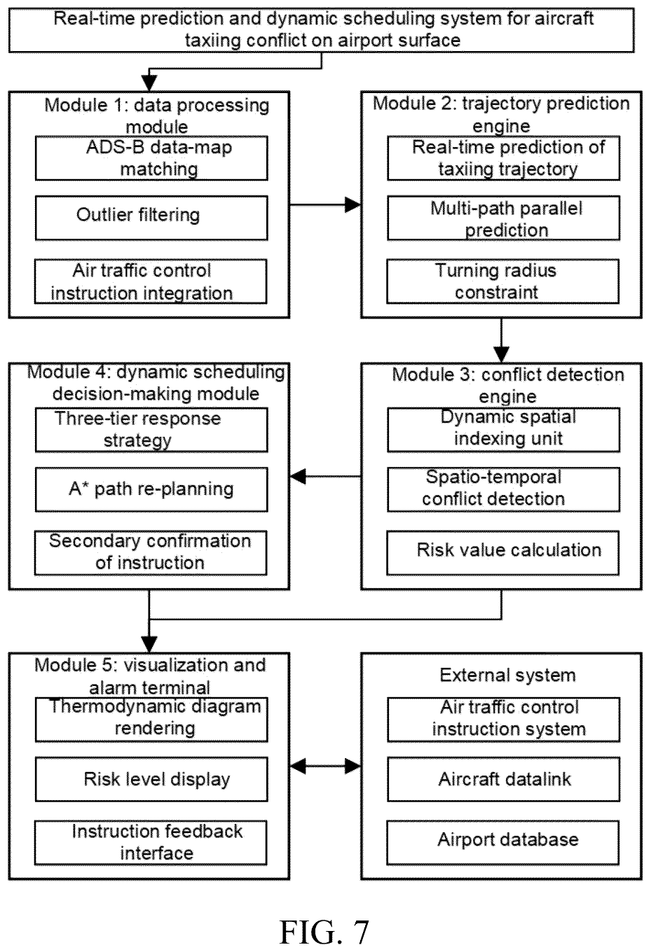

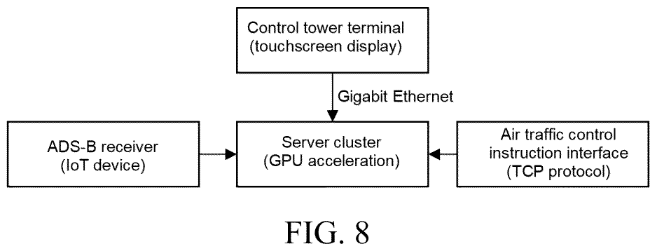

As shown in FIG. 7 and FIG. 8, an embodiment provides a real-time prediction and dynamic scheduling system for an aircraft taxiing conflict on an airport surface, which is applied to implement the above-described real-time prediction and dynamic scheduling method for the aircraft taxiing conflict on the airport surface, and includes the following modules.

Module 1: a data processing module, which is configured to load configuration data of an airport taxiway and receive/parse multi-source data streams in real time, including ADS-B data (position, velocity, and heading angle) from aircraft, extract a motion state, perform trajectory-map matching, receive air traffic control instruction data (waiting area assignments and taxiway closure status), and output a standardized motion state dataset.

Module 2: a trajectory prediction engine, which is configured to perform real-time trajectory prediction on the basis of motion state data, and generate a taxiing trajectory within the future time t.

Module 3: a conflict detection engine, which contains a dynamic spatial indexing unit configured to screen for aircraft pairs with overlapping trajectory bounding boxes on the basis of a dynamic R-Tree index, the dynamic R-Tree index being implemented via GPU parallel computing (<50 ms for a single full update); and a risk calculation unit configured to calculate a time difference (ΔT), a minimum spacing distance (ΔDₘᵢₙ), and a dynamic risk value (Risk) of the screened aircraft pairs.

Module 4: a dynamic scheduling decision-making module, which includes a hierarchical response unit configured to trigger three-tier responses on the basis of risk levels (log record/tower alarm/auto-avoidance instruction); and an instruction issuance unit configured to send instructions to pilots or control tower terminals via datalink. The avoidance instruction requires secondary confirmation by controllers before transmission to aircraft. The timeout time for confirmation is a configurable parameter, set to 5 seconds. After the timeout, a voice prompt will be given for manual handling.

Module 5: a visualization and alarm terminal, which is configured to aggregate risk values according to taxiway nodes and display a conflict thermodynamic diagram, a risk level and a scheduling instruction.

Finally, it is to be noted that: the embodiments described above are merely used to illustrate rather than limiting the technical solutions of the disclosure. Although the disclosure is described in detail by reference to the above embodiments, it is to be understood by those ordinary skilled in the art that: modifications or equivalent replacements can be made to the technical solutions of the disclosure without departing from the principle and scope of the disclosure, and these modifications or equivalent replacements are included in the scope of claims of the disclosure.

1. A real-time prediction and dynamic scheduling method for an aircraft taxiing conflict on an airport surface, comprising:
acquiring airport digital road network data, real-time aircraft signals, an air traffic control instruction, and flight plan data, performing data preprocessing, and generating original trajectories of aircraft using a hidden Markov model,
predicting future taxiing trajectories of the aircraft on the basis of the original trajectories, preprocessed real-time aircraft signals and preprocessed airport digital road network data to obtain predicted trajectories,
utilizing a dynamic R-Tree spatial indexing technology to screen for potentially conflicting aircraft on the basis of the predicted trajectories, determining whether trajectories of the potentially conflicting aircraft intersect, and generating a dynamic risk value,
executing a dynamic scheduling decision on the basis of the dynamic risk value, and generating an aircraft detour path on the basis of a path generation algorithm, and
re-planning a local path using a receding horizon control on the basis of real-time obtained data, wherein
during a process of determining whether the trajectories of the potentially conflicting aircraft intersect, if an intersection exists, an absolute value of a time difference between two aircraft arriving at an intersection point is calculated, and if no intersection exists, a minimum spacing distance between the two aircraft and an absolute value of a time difference between the two aircraft arriving at a closest point between the trajectories are calculated; and
a method for calculating the dynamic risk value is as follows:
$$Risk = \{ \begin{matrix}( α \cdot {e}^{- γΔ T} + β \cdot \frac{1}{Δ {D}_{min} + ϵ} + δ ) \cdot {w}_{direction} & trajectories intersect \\ ( α \cdot {e}^{- γΔ T} + β \cdot \frac{1}{Δ {D}_{min} + ϵ} ) \cdot {w}_{direction} & trajectories do not intersect\end{matrix}$$
where ΔT is the absolute value of the time difference between the two aircraft arriving at the intersection point or the absolute value of the time difference between the two aircraft arriving at the closest point between the trajectories, and if ΔT=0, it is directly regarded as a highest conflict risk without the need for calculation via formulas; ΔDₘᵢₙ is the minimum spacing distance between the two aircraft; α is a time urgency weight; β is a distance sensitivity weight; γ is a time decay coefficient, controlling a rate at which ΔT affects risk; ϵ is a smoothing factor parameter; δ is a fixed risk bonus parameter for an intersection scene; and w_{direction} is a direction weight.

2. The real-time prediction and dynamic scheduling method for the aircraft taxiing conflict on the airport surface according to claim 1, wherein the airport digital road network data comprises longitudes, latitudes, structures and lengths of a taxiway and a runway; the air traffic control instruction comprises a waiting instruction and a path change instruction; and the flight plan data comprises a taxiing path pre-stored in each aircraft.

3. The real-time prediction and dynamic scheduling method for the aircraft taxiing conflict on the airport surface according to claim 1, wherein a process of generating the original trajectories of the aircraft using the hidden Markov model comprises:
inputting deviation distances between trajectory points and center lines of various taxiways into a Gaussian probability-density function to calculate observation probabilities for the hidden Markov model; constructing a state transition probability matrix on the basis of transition frequencies between nodes in historical trajectories, and mapping original trajectory points onto the center lines of the taxiways to generate corrected trajectories; and performing linear interpolation on the corrected trajectories to generate the original trajectories.

4. The real-time prediction and dynamic scheduling method for the aircraft taxiing conflict on the airport surface according to claim 1, wherein a process of predicting the future taxiing trajectories of the aircraft comprises:
in a case that a prediction duration is no greater than remaining traveling time for a current taxiway section, predicting the trajectories on the basis of a uniform linear motion model;
in a case that the prediction duration is greater than the remaining traveling time for the current taxiway section, selecting a plurality of topologically connected paths for parallel prediction on the basis of an airport road network topology structure and the following priorities: a. pre-stored paths that match a flight plan database; b. paths specified by a real-time received air traffic control instruction; and c. feasible paths that satisfy a minimum turning radius of the aircraft; and stopping prediction in a case that a target runway entrance or a target parking stand entrance is detected; and
aggregating the trajectories of each aircraft over a future time period on the basis of predicted results to generate the predicted trajectories.

5. The real-time prediction and dynamic scheduling method for the aircraft taxiing conflict on the airport surface according to claim 1, wherein a process of utilizing the dynamic R-Tree spatial indexing technology to screen for the potentially conflicting aircraft comprises:
covering future trajectories of the aircraft within predicted time windows with minimum bounding rectangles on the basis of a dynamically expanded R-Tree index, wherein
it is determined that a potential conflict exists between the two aircraft if an overlap is detected between the minimum bounding rectangles of the future trajectories of the two aircraft, and otherwise, it is determined that no potential conflict exists; and
the dynamically expanded R-Tree index is constructed by time slices, with each slice updated independently to adapt to dynamic motion.

6. The real-time prediction and dynamic scheduling method for the aircraft taxiing conflict on the airport surface according to claim 1, wherein a process of executing the dynamic scheduling decision on the basis of the dynamic risk value comprises:
triggering a response measure on the basis of a level of the dynamic risk value, recording logs without intervention in a low risk scenario, sending an early warning to a control tower for manual monitoring in a medium risk scenario, and automatically generating an avoidance instruction in a high risk scenario, comprising a deceleration instruction or the detour path; and
determining the priority for aircraft avoidance, prioritizing deceleration or path adjustment to a trailing aircraft if the two aircraft travel in the same direction, and otherwise, prioritizing deceleration or path adjustment to an aircraft with a slower speed or greater payload; and prioritizing to adjust an aircraft on a descending taxiway if the two aircraft are heavy aircraft.

7. The real-time prediction and dynamic scheduling method for the aircraft taxiing conflict on the airport surface according to claim 1, wherein a process of generating the aircraft detour path on the basis of the path generation algorithm comprises:
performing calculation on the basis of a cost function, a path length and a real-time conflict risk value, the cost function being as follows:
Total cost f(n)=g(n)+h(n)+μ·R(n)
where g(n) is a path cost from a current aircraft position to a node n; h(n) is a Manhattan distance from the node n to a target node; R(n) is a risk cost from the current aircraft position to the node n; and μ is a risk weight coefficient; calculation formulas for R(n) and g(n) being as follows:
$$R ( n ) = {\sum }_{i = 1}^{n} ( {Length}_{i} \cdot {Risk}_{i} )$$
$$g ( n ) = {\sum }_{i = 1}^{n} ( {Length}_{i} \cdot {BaseWeight}_{i} )$$
where Lengthᵢ is a physical length (in meters) of an iₜₕ taxiway section; Riskᵢ is a dynamic risk value of the iₜₕ taxiway section; and BaseWeightᵢ is a basic weight coefficient for the iₜₕ taxiway section; and
generating the detour path using an improved A* algorithm on the basis of the calculated total cost.

8. The real-time prediction and dynamic scheduling method for the aircraft taxiing conflict on the airport surface according to claim 7, wherein a process of generating the detour path using the improved A* algorithm comprises:
an initialization phase: loading airport road network topology data, and defining a path start point S and a target point G; an open list being a set of nodes to be examined, initially containing only a start point, and a closed list being a set of nodes that have been examined, initially an empty set;
path search loop: if the open list is empty, terminating the process and returning to no solution, and otherwise, selecting a node n with a smallest total cost f(n) from the open list and moving same to the closed list; and if the current node n is the target point G, backtracking to output a complete path;
adjacent node expansion and filtering: generating all adjacent nodes of the current node n; filtering out adjacent nodes that violate a minimum turning radius constraint of the aircraft; and excluding nodes of the taxiway which have a one-way traveling direction conflicting with a current moving direction; and
node state update: if an adjacent node is not in the open list or the closed list, adding the adjacent node to the open list; if an adjacent node is already in the open list and a newly calculated value f(n) is better, updating a cost value and a parent node of the adjacent node; and then returning to the path search loop to continue searching until a goal point is reached or the open list is exhausted.

9. A real-time prediction and dynamic scheduling system for an aircraft taxiing conflict on an airport surface based on the method according to claim 1, comprising a data processing module, a trajectory prediction engine, a conflict detection engine, a dynamic scheduling decision-making module, and a visualization and alarm terminal, wherein
the data processing module is configured to receive data and perform data preprocessing, and generate the original trajectories of the aircraft using the hidden Markov model;
the trajectory prediction engine is configured to predict the future taxiing trajectories of the aircraft on the basis of the original trajectories and the preprocessed data to obtain the predicted trajectories;
the conflict detection engine is configured to utilize the dynamic R-Tree spatial indexing technology to screen for the potentially conflicting aircraft, determine whether the trajectories of the potentially conflicting aircraft intersect, and generate the dynamic risk value;
the dynamic scheduling decision-making module is configured to execute the dynamic scheduling decision on the basis of the dynamic risk value, and generate the aircraft detour path on the basis of the path generation algorithm; and
the visualization and alarm terminal is configured to render a thermodynamic diagram of an airport digital road network, display a risk level, and display feedback of the dynamic scheduling decision.

10. A real-time prediction and dynamic scheduling system for an aircraft taxiing conflict on an airport surface based on the method according to claim 2, comprising a data processing module, a trajectory prediction engine, a conflict detection engine, a dynamic scheduling decision-making module, and a visualization and alarm terminal, wherein
the data processing module is configured to receive data and perform data preprocessing, and generate the original trajectories of the aircraft using the hidden Markov model;
the trajectory prediction engine is configured to predict the future taxiing trajectories of the aircraft on the basis of the original trajectories and the preprocessed data to obtain the predicted trajectories;
the conflict detection engine is configured to utilize the dynamic R-Tree spatial indexing technology to screen for the potentially conflicting aircraft, determine whether the trajectories of the potentially conflicting aircraft intersect, and generate the dynamic risk value;
the dynamic scheduling decision-making module is configured to execute the dynamic scheduling decision on the basis of the dynamic risk value, and generate the aircraft detour path on the basis of the path generation algorithm; and
the visualization and alarm terminal is configured to render a thermodynamic diagram of an airport digital road network, display a risk level, and display feedback of the dynamic scheduling decision.

11. A real-time prediction and dynamic scheduling system for an aircraft taxiing conflict on an airport surface based on the method according to claim 3, comprising a data processing module, a trajectory prediction engine, a conflict detection engine, a dynamic scheduling decision-making module, and a visualization and alarm terminal, wherein
the data processing module is configured to receive data and perform data preprocessing, and generate the original trajectories of the aircraft using the hidden Markov model;
the trajectory prediction engine is configured to predict the future taxiing trajectories of the aircraft on the basis of the original trajectories and the preprocessed data to obtain the predicted trajectories;
the conflict detection engine is configured to utilize the dynamic R-Tree spatial indexing technology to screen for the potentially conflicting aircraft, determine whether the trajectories of the potentially conflicting aircraft intersect, and generate the dynamic risk value;
the dynamic scheduling decision-making module is configured to execute the dynamic scheduling decision on the basis of the dynamic risk value, and generate the aircraft detour path on the basis of the path generation algorithm; and
the visualization and alarm terminal is configured to render a thermodynamic diagram of an airport digital road network, display a risk level, and display feedback of the dynamic scheduling decision.

12. A real-time prediction and dynamic scheduling system for an aircraft taxiing conflict on an airport surface based on the method according to claim 4, comprising a data processing module, a trajectory prediction engine, a conflict detection engine, a dynamic scheduling decision-making module, and a visualization and alarm terminal, wherein
the data processing module is configured to receive data and perform data preprocessing, and generate the original trajectories of the aircraft using the hidden Markov model;
the trajectory prediction engine is configured to predict the future taxiing trajectories of the aircraft on the basis of the original trajectories and the preprocessed data to obtain the predicted trajectories;
the conflict detection engine is configured to utilize the dynamic R-Tree spatial indexing technology to screen for the potentially conflicting aircraft, determine whether the trajectories of the potentially conflicting aircraft intersect, and generate the dynamic risk value;
the dynamic scheduling decision-making module is configured to execute the dynamic scheduling decision on the basis of the dynamic risk value, and generate the aircraft detour path on the basis of the path generation algorithm; and the visualization and alarm terminal is configured to render a thermodynamic diagram of an airport digital road network, display a risk level, and display feedback of the dynamic scheduling decision.

13. A real-time prediction and dynamic scheduling system for an aircraft taxiing conflict on an airport surface based on the method according to claim 5, comprising a data processing module, a trajectory prediction engine, a conflict detection engine, a dynamic scheduling decision-making module, and a visualization and alarm terminal, wherein
the data processing module is configured to receive data and perform data preprocessing, and generate the original trajectories of the aircraft using the hidden Markov model;
the trajectory prediction engine is configured to predict the future taxiing trajectories of the aircraft on the basis of the original trajectories and the preprocessed data to obtain the predicted trajectories;
the conflict detection engine is configured to utilize the dynamic R-Tree spatial indexing technology to screen for the potentially conflicting aircraft, determine whether the trajectories of the potentially conflicting aircraft intersect, and generate the dynamic risk value;
the dynamic scheduling decision-making module is configured to execute the dynamic scheduling decision on the basis of the dynamic risk value, and generate the aircraft detour path on the basis of the path generation algorithm; and
the visualization and alarm terminal is configured to render a thermodynamic diagram of an airport digital road network, display a risk level, and display feedback of the dynamic scheduling decision.

14. A real-time prediction and dynamic scheduling system for an aircraft taxiing conflict on an airport surface based on the method according to claim 6, comprising a data processing module, a trajectory prediction engine, a conflict detection engine, a dynamic scheduling decision-making module, and a visualization and alarm terminal, wherein
the data processing module is configured to receive data and perform data preprocessing, and generate the original trajectories of the aircraft using the hidden Markov model;
the trajectory prediction engine is configured to predict the future taxiing trajectories of the aircraft on the basis of the original trajectories and the preprocessed data to obtain the predicted trajectories;
the conflict detection engine is configured to utilize the dynamic R-Tree spatial indexing technology to screen for the potentially conflicting aircraft, determine whether the trajectories of the potentially conflicting aircraft intersect, and generate the dynamic risk value;
the dynamic scheduling decision-making module is configured to execute the dynamic scheduling decision on the basis of the dynamic risk value, and generate the aircraft detour path on the basis of the path generation algorithm; and
the visualization and alarm terminal is configured to render a thermodynamic diagram of an airport digital road network, display a risk level, and display feedback of the dynamic scheduling decision.

15. A real-time prediction and dynamic scheduling system for an aircraft taxiing conflict on an airport surface based on the method according to claim 7, comprising a data processing module, a trajectory prediction engine, a conflict detection engine, a dynamic scheduling decision-making module, and a visualization and alarm terminal, wherein
the data processing module is configured to receive data and perform data preprocessing, and generate the original trajectories of the aircraft using the hidden Markov model;
the trajectory prediction engine is configured to predict the future taxiing trajectories of the aircraft on the basis of the original trajectories and the preprocessed data to obtain the predicted trajectories;
the conflict detection engine is configured to utilize the dynamic R-Tree spatial indexing technology to screen for the potentially conflicting aircraft, determine whether the trajectories of the potentially conflicting aircraft intersect, and generate the dynamic risk value;
the dynamic scheduling decision-making module is configured to execute the dynamic scheduling decision on the basis of the dynamic risk value, and generate the aircraft detour path on the basis of the path generation algorithm; and
the visualization and alarm terminal is configured to render a thermodynamic diagram of an airport digital road network, display a risk level, and display feedback of the dynamic scheduling decision.

16. A real-time prediction and dynamic scheduling system for an aircraft taxiing conflict on an airport surface based on the method according to claim 8, comprising a data processing module, a trajectory prediction engine, a conflict detection engine, a dynamic scheduling decision-making module, and a visualization and alarm terminal, wherein
the data processing module is configured to receive data and perform data preprocessing, and generate the original trajectories of the aircraft using the hidden Markov model;
the trajectory prediction engine is configured to predict the future taxiing trajectories of the aircraft on the basis of the original trajectories and the preprocessed data to obtain the predicted trajectories;
the conflict detection engine is configured to utilize the dynamic R-Tree spatial indexing technology to screen for the potentially conflicting aircraft, determine whether the trajectories of the potentially conflicting aircraft intersect, and generate the dynamic risk value;
the dynamic scheduling decision-making module is configured to execute the dynamic scheduling decision on the basis of the dynamic risk value, and generate the aircraft detour path on the basis of the path generation algorithm; and
the visualization and alarm terminal is configured to render a thermodynamic diagram of an airport digital road network, display a risk level, and display feedback of the dynamic scheduling decision.
